(19) United States
(12) Patent Application Publication
(10) Pub. No.: US 2019/0061147 A1
(43) Pub. Date: Feb. 28, 2019

(54) Methods and Apparatus for Pruning Experience Memories for Deep Neural Network-Based Q-Learning

(71) Applicant: Neurala, Inc., Boston, MA (US)

(72) Inventor: Matthew Luciw, Boston, MA (US)

(21) Appl. No.: 16/171,912

(22) Filed: Oct. 26, 2018

Related U.S. Application Data
(63) Continuation of application No. PCT/US2017/029866, filed on Apr. 27, 2017.
(60) Provisional application No. 62/328,344, filed on Apr. 27, 2016.

(51) Int. Cl. B25J 9/16; G05B 13/02; G06N 3/08

(52) U.S. Cl. CPC B25J 9/161; G05B 13/027; B25J 9/163; G06N 3/084; G06N 3/082

(57) ABSTRACT

The present technology involves collecting a new experience by an agent, comparing the new experience to experiences stored in the agent's memory, and either discarding the new experience or overwriting an experience in the memory with the new experience based on the comparison. For instance, the agent or an associated processor may determine how similar the new experience is to the stored experiences. If the new experience is too similar, the agent discards it; otherwise, the agent stores it in the memory and discards a previously stored experience instead. Collecting and selectively storing experiences based on the experiences' similarity to previously stored experiences addresses technological problems and yields a number of technological improvements. For instance, relieves memory size constraints, reduces or eliminates the chances of catastrophic forgetting by a neural network, and improves neural network performance.

### CROSS-REFERENCE TO RELATED APPLICATION(S)

This application is a bypass continuation application of International Application No. PCT/US2017/029866, entitled “Methods and Apparatus for Pruning Experience Memories for Deep Neural Network-Based Q-Learning,” filed Apr. 27, 2017, which claims the priority benefit, under 35 U.S.C. § 119(e), of U.S. Application No. 62/328,344, entitled “Methods and Apparatus for Pruning Experience Memories for Deep Neural Network-Based Q-Learning,” filed on Apr. 27, 2016. This application is incorporated herein by reference in its entirety.

### BACKGROUND

In reinforcement learning, an agent interacts with an environment. During the course of its interactions with the environment, the agent collects experiences. A neural network associated with the agent can use these experiences to learn a behavior policy. That is, the neural network that is associated with or controls the agent can use the agent's collection of experiences to learn how the agent should act in the environment.

In order to be able to learn from past experiences, the agent stores the collected experiences in a memory, either locally or connected via a network. Storing all experiences to train a neural network associated with the agent can prove useful in theory. However, hardware constraints make storing all of the experiences impractical or even impossible as the number of experiences grows.

Pruning experiences stored in the agent's memory can relieve constraints on collecting and storing experiences. But naïve pruning, such as weeding out old experiences in a first-in first-out manner, can lead to “catastrophic forgetting.” Catastrophic forgetting means that new learning can cause previous learning to be undone and is caused by the distributed nature of backpropagation-based learning. Due to catastrophic forgetting, continual re-training of experiences is necessary to prevent the neural network from “forgetting” how to respond to the situations represented by those experiences. Said another way, by weeding out experiences in a first-in first-out manner, the most recent experiences will be better represented in the neural network and the older experiences will be forgotten, making it more difficult for the neural network to respond to situations represented by the older experiences. Catastrophic forgetting can be avoided by simply re-learning the complete set of experiences, including the new ones, but re-learning the entire history of the agent's experience can take too long to be practical, especially with a large set of experiences that grows at a rapid rate.

### SUMMARY

Embodiments of the present technology include methods for generating an action for a robot. An example computer-implemented method comprises collecting a first experience for the robot. The first experience represents a first state of the robot at a first time, a first action taken by the robot at the first time, a first reward received by the robot in response to the first action, and a second state of the robot in response to the first action at a second time after the first time. A degree of similarity between the first experience and plurality of experiences can be determined. The plurality of experiences can be stored in a memory for the robot. The method also comprises pruning the plurality of experiences in the memory based on the degree of similarity between the first experience and the plurality of experiences to form a pruned plurality of experiences stored in the memory. A neural network associated with the robot can be trained with the pruned plurality of experiences and a second action for the robot can be generated using the neural network.

In some cases, the pruning further comprises computing a distance from the first experience for each experience in the plurality of experiences. For each experience in the plurality of experiences, the distance to another distance of that experience from each other experience in the plurality of experiences can be compared. A second experience can be removed from the memory based on the comparison. The second experience can be at least one of the first experience and an experience from the plurality of experiences. The second experience can be removed from the memory based on a probability that the distance of the second experience from the first experience and each experience in the plurality of experiences is less than a user-defined threshold.

In some cases, the pruning can further include ranking the first experience and each experience in the plurality of experiences. Ranking the first experience and each experience in the plurality of experiences can include creating a plurality of clusters based at least in part on synaptic weights and automatically discarding the first experience upon determining that the first experience fits one of the plurality of clusters. The first experience and each experience in the plurality of experiences can be encoded. The encoded experiences can be compared to the plurality of clusters.

In some cases, the neural network generates an output at a first input state based at least in part on the pruned plurality of experiences. The pruned plurality of experiences can include a diverse set of states of the robot. In some cases, generating the second action for the robot can include determining that the robot is in the first state and selecting the second action to be different than the first action.

The method can also comprise collecting a second experience for the robot. The second experience represents a second state of the robot, the second action taken by the robot in response to the second state, a second reward received by the robot in response to the second action, and a third state of the robot in response to the second action. A degree of similarity between the second experience and the pruned plurality of experiences can be determined. The method can also comprise pruning the pruned plurality of experiences in the memory based on the degree of similarity between the second experience and the pruned plurality of experiences.

An example system for generating a second action for a robot comprises an interface to collect a first experience for the robot. The first experience represents a first state of the robot at a first time, a first action taken by the robot at the first time, a first reward received by the robot in response to the first action, and a second state of the robot in response to the first action at a second time after the first time. The system also comprises a memory to store at least one of a plurality of experiences and a pruned plurality of experiences for the robot. The system also comprises a processor that is in digital communication with the interface and the memory. The processor can determine a degree of similarity between the first experience and the plurality of experiences stored in the memory. The processor can prune the plurality of experiences in the memory based on the degree of similarity between the first experience and the plurality of experiences to form the pruned plurality of experiences. The memory can be updated by the processor to store the pruned plurality of experiences. The processor can train a neural network associated with the robot with the pruned plurality of experiences. The processor can generate the second action for the robot using the neural network.

In some cases, the system can further comprise a cloud brain that is in digital communication with the processor and the robot to transmit the second action to the robot.

In some cases, the processor is configured to compute a distance from the first experience for each experience in the plurality of experiences. The processor can compare the distance to another distance of that experience from each other experience in the plurality of experiences for each experience in the plurality of experiences. A second experience can be removed from the memory via the processor based on the comparison. The second experience can be at least one of the first experience and an experience from the plurality of experiences. The processor can be configured to remove the second experience from the memory based on a probability determination of the distance of the second experience from the first experience and each experience in the plurality of experiences being less than a user-defined threshold.

The processor can also be configured to prune the memory based on ranking the first experience and each experience in the plurality of experiences. The processor can create a plurality of clusters based at least in part on synaptic weights, rank the first experience and the plurality of experiences based on the plurality of clusters, and can automatically discard the first experience upon determination that the first experience fits one of the plurality of clusters. The processor can encode each experience in the plurality of experiences, encode the first experience, and compare the encoded experiences to the plurality of clusters. In some cases, the neural network can generate an output at a first input state based at least in part on the pruned plurality of experiences.

An example computer-implemented method for updating a memory comprises receiving a new experience from a computer-based application. The memory stores a plurality of experiences received from the computer-based application. The method also comprises determining a degree of similarity between the new experience and the plurality of experiences. The new experience can be added based on the degree of similarity. At least one of the new experience and an experience from the plurality of experiences can be removed based on the degree of similarity. The method comprises sending an updated version of the plurality of experiences to the computer-based application.

Embodiments of the present technology include method for improving sample queue management in deep reinforcement learning systems that use experience replay to boost their learning. More particularly, the present technology involves efficiently and effectively training neural networks, deep networks, and in general optimizing learning in parallel distributed systems of equations controlling autonomous cars, drones, or other robots in real time.

Compared to other technology, the present technology can accelerate and improve convergence in reinforcement learning in such systems, namely and more so as the size of the experience queue decreases. More particularly, the present technology involves sampling of the queue for experience replaying in neural network and deep network systems for better selecting the data samples to replay to the system during the so-called “experience replay.” The present technology is useful for, but is not limited to, neural network systems controlling movement, motors, and steering commands in self-driving cars, drones, ground robots, and underwater robots, or in any resource-limited device that controls online and real-time reinforcement learning.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a flow diagram depicting actions, states, responses, and rewards that form an experience for an agent.

FIG. 2 is a flow diagram depicting a neural network operating in feedforward mode, e.g., used for the greedy behavior policy of an agent.

FIG. 3 is a flow diagram depicting an experience replay memory, which new experiences are added to, and from which a sample of experiences are drawn with which to train a neural network.

FIG. 4 shows flow diagrams depicting three dissimilarity-based pruning processes for storing experiences in a memory.

FIG. 5 illustrates an example match-based pruning process for storing experiences in a memory for an agent.

FIG. 6 is a flow diagram depicting an alternative representation of the pruning process in FIG. 5.

FIG. 7 is a system diagram of a system that uses deep reinforcement learning and experience replay from a memory storing a pruned experience queue.

FIG. 8 illustrates a self-driving car that acquires experiences with a camera, LIDAR, and/or other data sources, uses pruning to curate experiences stored in a memory, and deep reinforcement learning and experience replay of the pruned experiences to improve self-driving performance.

### DETAILED DESCRIPTION

In Deep Reinforcement Learning (RL), experiences collected by an agent are provided to a neural network associated with the agent in order to train the neural network to produce actions or the values of potential actions such that the agent can act to increase or maximize expected future reward. Since it may be impractical or impossible to store all experiences collected by the agent in a memory due to limits on the memory's size, reinforcement learning systems implement techniques for storage reduction. One approach to implementing storage reduction is to selectively remove experiences from the memory. However, neural networks that are trained by merely weeding out old experiences in a first-in first-out manner encounter forgetting problems. That is, old experiences that may contribute towards learning are forgotten since they are removed from the memory. Another disadvantage of merely removing old experiences is that it does not address experiences that are highly correlated and redundant. Training a neural network with a set of highly correlated and similar experiences may be inefficient and can slow the learning process.

The present technology provides ways to selectively replace experiences in a memory by determining a degree of similarity between an incoming experience and the experiences already stored in the memory. As a result, old experiences that may contribute towards learning are not forgotten and experiences that are highly correlated may be removed to make space for dissimilar/more varied experiences in the memory.

The present technology is useful for, but is not limited to, neural network systems that control movements, motors, and steering commands in self-driving cars, drones, ground robots, and underwater robots. For instance, for a self-driving car, experiences characterizing speed and steering angle for obstacles encountered along a path can be collected dynamically. These experiences can be stored in a memory. As new experiences are collected, a processor determines a degree of similarity between the new experience and the previously stored experiences. For instance, if experiences stored in the memory include speed and steering angles for obstacle A and if the new experience characterizes speed and steering angle for obstacle B, which is vastly different from obstacle A, the processor prunes (removes) a similar experience from the memory (e.g., one of the experiences relating to obstacle A) and inserts the new experience relating to obstacle B. The neural network for the self-driving car is trained based on the experiences in the pruned memory, including the new experience about obstacle B.

Because the memory is pruned based on experience similarity, can be small enough to sit “on the edge”—e.g., on the agent, which may be a self-driving car, drone, or robot—instead of being located remotely and connected to the agent via a network connection. And because the memory is on the edge, it can be used to train the agent on the edge. This reduces or eliminates the need for a network connection, enhancing the reliability and robustness of both experience collection and neural network training. These memories may be harvested as desired (e.g., periodically, when upstream bandwidth is available, etc.) and aggregated at a server. The aggregated data may be sampled and distributed to existing and/or new agents for better performance at the edge.

The present technology can also be useful for video games and other simulated environments. For instance, agent behavior in video games can be developed by collecting and storing experiences for agents in the game while selectively pruning the memory based on a degree of similarity. In such environments, learning from vision involves experiences that include high-dimensional images, and so a large amount of storage can be saved using the present technology.

Optimally storing a sample of experiences in the memory can improve and accelerate convergence in reinforcement learning, especially learning on resource-limited devices “at the edge”. Thus, the present technology provides inventive methods for faster learning while implementing techniques for using less memory. Therefore, using the present technology a smaller memory size can be used to achieve a given learning performance goal.

Experience Collection and Reinforcement Learning

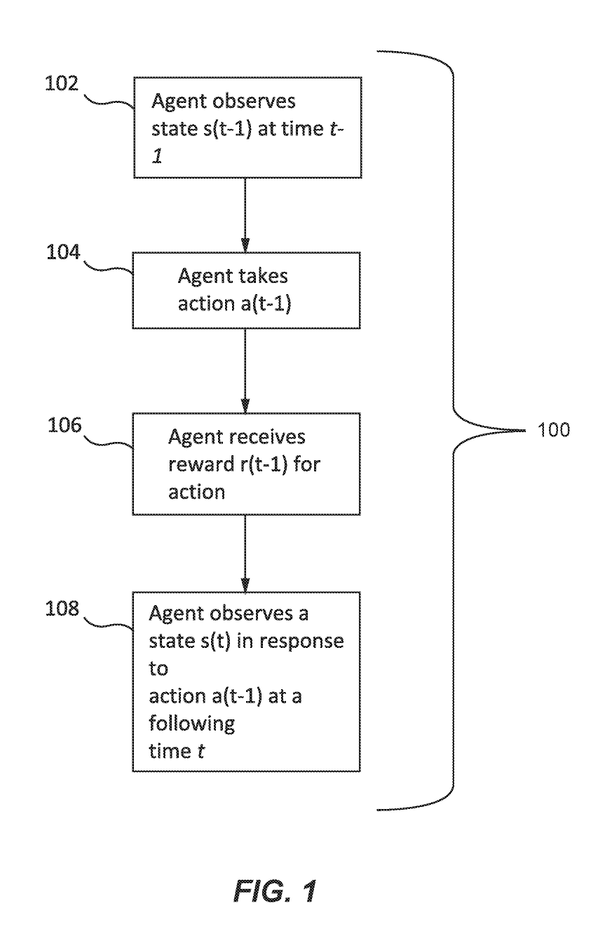

FIG. 1 is a flow diagram depicting actions, states, responses, and rewards that form an experience 100 for an agent. At 102, the agent observes a (first) state sₜ₋₁ at a (first) time t-1. The agent may observe this state with an image sensor, microphone, antenna, accelerometer, gyroscope, or any other suitable sensor. It may read settings on a clock, encoder, actuator, or navigation unit (e.g., an inertial measurement unit). The data representing the first state can include information about the agent's environment, such as pictures, sounds, or time. It can also include information about the agent, including its speed, heading, internal state (e.g., battery life), or position.

During the state sₜ₋₁, the agent takes an action aₜ₋₁ (e.g., at 104). This action may involve actuating a wheel, rotor, wing flap, or other component that controls the agent's speed, heading, orientation, or position. The action may involve changing the agent's internal settings, such as putting certain components into a sleep mode to conserve battery life. The action may affect the agent's environment and/or objects within the environment, for example, if the agent is in danger of colliding with one of those objects. Or it may involve acquiring or transmission data, e.g., taking a picture and transmitting it to a server.

At 106, the agent receives a reward rₜ₋₁ for the action aₜ₋₁. The reward may be predicated on a desired outcome, such as avoiding an obstacle, conserving power, or acquiring data. If the action yields the desired outcome (e.g., avoiding the obstacle), the reward is high; otherwise, the reward may be low. The reward can be binary or may fall on or within a range of values.

At 108, in response to the action aₜ₋₁, the agent observes a following (second) state sₜ. This state sₜ is observed at a following (second) time t. The state sₜ₋₁, action aₜ₋₁, reward rₜ₋₁, and the following state sₜ collectively form an experience eₜ 100 at time t. At each time step t the agent has observed a state sₜ₋₁, taken action aₜ₋₁, gotten reward rₜ₋₁ and observed outcome state sₜ. The observed state sₜ₋₁, action aₜ₋₁, reward rₜ₋₁ and observed outcome state sₜ collectively form an experience 100 as shown in FIG. 1.

In Reinforcement Learning (RL), an agent collects experiences as it interacts with its environment and tries to learn how to act such that it gets as much reward as possible. The agent's goal is to use all of its experiences to learn a behavior policy π=P(a|s), that it will use to select actions, which, when followed, will enable the agent to collect the maximum cumulative reward, in expectation, out of all such policies. In value-based RL, an optimal (desired) behavior policy corresponds to the optimal value function, such as the action-value function, typically denoted Q,

$${Q}^{*} ( s , a ) = {max}_{π} E [ {r}_{t} + γ {r}_{t + 1} + {γ}^{2} {r}_{t + 2} + … \vert {s}_{t} = s , {a}_{t} = a , π ] . \qquad ( 1 )$$

where γ is a discount factor that controls the influence of temporally distant outcomes on the action-value function. Q*(s, a) assigns a value to any state action pair. If Q* is known, to follow the associated optimal behavior policy, the agent then just has to take the action with the highest value for each current observation s.

Deep Neural Networks (DNNs) can be used to approximate the optimal action-value functions (the Q* function) of reinforcement learning agents with high-dimensional state inputs, such as raw pixels of video. In this case, the action-value function Q(s, a; θ)≈Q*(s, a) is parameterized by the network parameters θ (such as the weights).

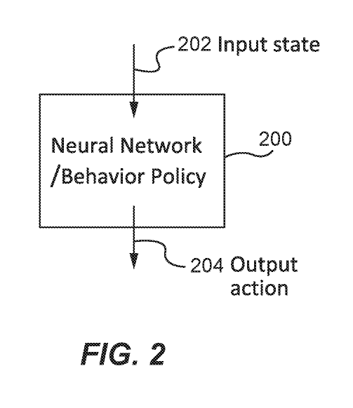

FIG. 2 is a flow diagram depicting a neural network 200 that operates as the behavior policy π in the feedforward mode. Given an input state 202, the neural network 200 outputs a vector of action values 204 (e.g., braking and steering values for a self-driving car) via a set of Q-values associated with potential actions. This vector is computed using neural network weights that are set or determined by training the neural network with data representing simulated or previously acquired experiences. The Q-values can be converted into probabilities through standard methods (e.g., parameterized softmax), and then to actions 204. The feedforward mode is how the agent gets the Q-values for potential actions, and how it chooses the most valuable actions.

The network is trained, via backpropagation, to learn (to approximate) the optimal action-value function by converting the agent's experiences into training samples (x, y), where x is the network input and y are the network targets. The network input is x=ϕ(s) where ϕ is some function that preprocesses the observations to make them more suitable for the network. In order to progress towards the optimal action-value function, the targets y are set to maintain the consistency,

$$Q ( {x}_{t - 1} , {a}_{t - 1} ) = {r}_{t - 1} + γ {max}_{{a}^{′}} Q ( {x}_{t} , {a}^{′} ) . \qquad ( 2 )$$

Following this, in a basic case, the targets can be set to

$${y}_{t - 1}^{Q} = {r}_{t - 1} + γ {max}_{{a}^{′}} Q ( {x}_{t} , {a}^{′} ; {θ}_{t} ) . \qquad ( 3 )$$

Eq. 3 can be improved by introducing a second, target network, with parameters θ⁻, which is used to find the most valuable actions (and their values), but is not necessarily updated incrementally. Instead, another network (the “online” network) has its parameters updated. The online network parameters θ replaces the target network parameters θ⁻ every τ time steps. Replacing Eq. 3 by

$${y}_{t - 1}^{DQN} = {r}_{t - 1} + γ {max}_{{a}^{′}} Q ( {x}_{t} , {a}^{′} ; {θ}_{t}^{-} ) , \qquad ( 4 )$$

yields the target used in the Deep Q-Network (DQN) algorithm of Mnih et al., “Human-level control through deep reinforcement learning,” Nature, 518(7540):529-533, 2015, which is incorporated herein by reference in its entirety.

An improved version of DQN, called Double DQN, decouples the selection and evaluation, as follows:

$${y}_{t - 1}^{DDQN} = {r}_{t - 1} + γ Q ( {x}_{t} , arg {max}_{{a}^{′}} Q ( {x}_{t} , {a}^{′} ; {θ}_{t} ) ; {θ}_{t}^{-} ) . \qquad ( 5 )$$

Decoupled selection and evaluation reduces the chances that the max operator will use the same values to both select and evaluate an action, which can cause a biased overestimation of values. In practice, it leads to accelerated convergence rates and better eventual policies compared to standard DQN.

Experience Replay

In order to keep the model bias down, back-propagation-trained neural networks should draw training samples in an i.i.d. fashion. In a conventional approach, the samples are collected as the agent interacts with an environment, so the samples are highly biased if they are trained in the order they arrive. A second issue is, due to the well-known forgetting problem of backpropagation-trained nets, the more recent experiences are better represented in the model, while older experiences are forgotten, thus preventing true convergence if the neural network is trained in this fashion.

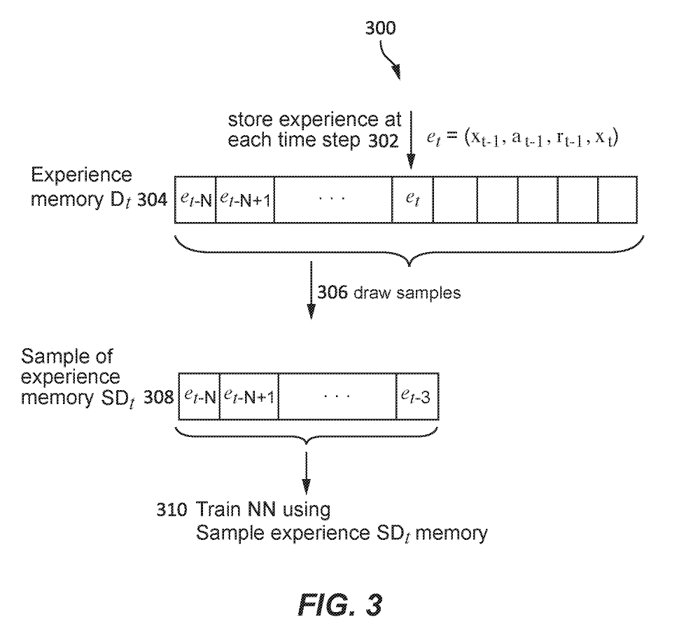

To mitigate such issues, a technique called experience replay is used. FIG. 3 is a flow diagram depicting experience replay process 300 for training a neural network. As depicted in step 302, at each time step, experience=(xₜ₋₁,aₜ₋₁,rₜ₋₁,xₜ) such as experience 100 in FIG. 1, is stored in experience memory 304 expressed as Dₜ={e_{t-N}, e_{t-N+1}, . . . , eₜ}. Thus, the experience memory 304 includes a collection of previously collected experiences. At 306, a set SDₜ (e.g., set 308) of training samples are drawn from the experience memory 304. That is, when the neural network is to be updated, a set of training samples 308 are drawn as a minibatch of experiences from 304. Each experience in the minibatch can be drawn from the memory 304 in such a way that there are reduced correlations in the training data (e.g., uniformly), which may potentially accelerate learning, but this does not address the size and the contents (bias) of the experience memory Dₜ itself. At 310, the set of training samples 308 are used to train the neural network. Training a network with a good mix of experiences from the memory can reduce temporal correlations, allowing the network to learn in a much more stable way, and in some cases is essential for the network to learn anything useful at all.

As the network does not (and should not) have to be trained on samples as they arrive, Eqs. 3, 4, and 5 are not tied to the sample of the current time step: {xₜ₋₁, aₜ₋₁, rₜ₋₁, xₜ}, —they can apply to whatever sample eⱼ is drawn from the replay memory (e.g., set of training samples 308 in FIG. 3).

With an experience memory, the system uses a strategy for which experiences to replay (e.g., prioritization; how to sample from experience memory D) and which experiences to store in experience memory D (and which experiences not to store).

Which Experiences to Replay

Prioritizing experiences in model-based reinforcement learning can accelerate convergence to the optimal policy. Prioritizing involves assigning a probability to each experience in the memory, which determines the chance the experience is drawn from the memory into the sample for network training. In the model-based case, experiences are prioritized based on the expected change in the value function if they are executed, in other words, the expected learning progress. In the model-free case, an approximation of expected learning progress is the temporal difference (TD) error,

δ=rₜ₋₁+γ max a′Q(xₜ,a′)−Q(xₜ₋₁,aₜ₋₁), (6)

Using TD-error as the basis for prioritization for Double DQN increases learning efficiency and eventual performance.

However, other prioritization methods could be used, such as prioritization by dissimilarity. Probabilistically choosing to train the network preferentially with experiences that are dissimilar to others can break imbalances in the dataset. Such imbalances emerge in RL when the agent cannot explore its environment in a truly uniform (unbiased) manner. However, when the memory size of D is limited due to resource constraints, the entirety of D may be biased in favor of certain experiences over others, which may have been forgotten (removed from D). In this case, it may not be possible to truly remove bias, as the memories have been eliminated.

Which Experiences to Store

Storing all memories is, in theory, useful. An old experience, which may not have contributed to learning when it was collected, can suddenly become useful once the agent has accumulated enough knowledge to know what to do with it. But unlimited experience memories can quickly grow too large for modern hardware, especially when the inputs are high-dimensional, such as images. Instead of storing everything, a sliding window is typically used, in other words, a first-in first-out queue, and the size of the replay memory set to some maximum number of experiences N. A large memory (e.g., one that stores one million experiences) has become fairly standard in state-of-the-art systems. As a byproduct of this, the storage requirements for the experience memory have become much larger than the storage requirements for the network itself. A method for reducing the size of the replay memory, without effecting the learning efficiency, is useful when storage is an issue.

A prioritization method can also be applied to pruning the memory. Instead of preferentially sampling the experiences with the highest priorities from experience memory D, the experiences with the lowest priorities are preferentially removed from experience memory D. Erasing memories is more final than assigning priorities, but can be necessary depending on the application.

Pruning Experience Memories

The following processes focus on pruning experience memories. But these processes can also apply to prioritization, if the outcome probabilities, which are used to select which experience(s) to remove, are inverted and used as priorities.

Similarity-Based Pruning

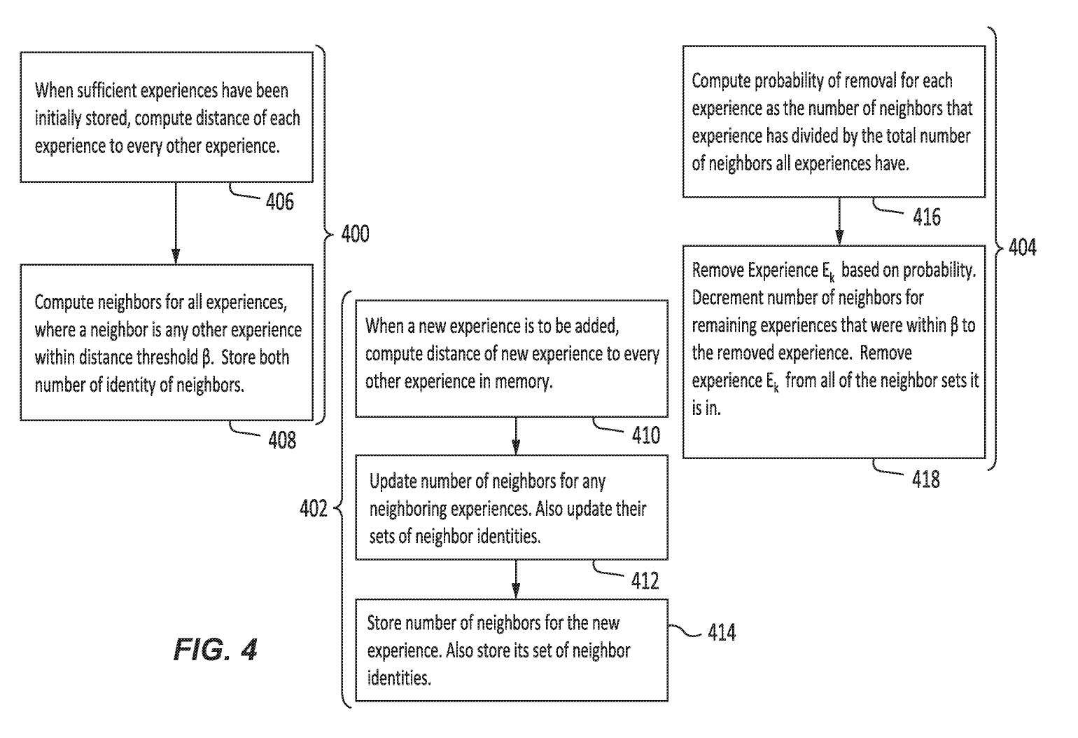

FIG. 4 is a flow diagram depicting three dissimilarity-based pruning processes—process 400, process 402, and process 404—as described in detail below. The general idea is to maintain a list of neighbors for each experience, where a neighbor is another experience with distance less than some threshold. The number of neighbors an experience has determines its probability of removal. The pruning mechanism uses a one-time initialization with quadratic cost, in process 400, which can be done, e.g., when the experience memory reaches capacity for the first time. Other costs are of linear in complexity. Further, the only additional storage required is number of neighbors and list of neighbors for each experience (much smaller than an all-pairs distance matrix). When an experience is added (process 402), the distance from it to other experiences is computed, and the neighbor counts/lists updated. When an experience is to be pruned (process 404), the probabilities are generated from the stored neighbor counts, and the pruned experience

{D, M, L} ← InitializePruning (D, β, d): Process 400

| | //D: experience memory of experiences of the type | | | |
|---|---|---|---|---|
| | eₜ = {xᵢ₋₁, aᵢ₋₁, rᵢ₋₁, x₁} | | | |
| | //N: number of experiences in the memory | | | |
| | //β: distance threshold to determine if two experiences | | | |
| | are neighbors | | | |
| | //d(eⱼ, eₖ): distance metric to compare two experiences | | | |
| | //mⱼ: number (count) of neighbors for experience j | | | |
| | //M: container of all neighbor counts | | | |
| | //lⱼ: set of neighbors of experience j | | | |
| | //L: container of all neighbor sets | | | |
| 1 | for j ← 1 to N do | | | |
| 2 | \| | mⱼ ← 0 | | |
| 3 | \| | lⱼ ← {j} | | |
| 4 | end | | | |
| 5 | for j ← 1 to N do | | | |
| 6 | \| | for k ← 1 to N do | | |
| 7 | \| | \| | if d(eⱼ, eₖ) < β then | |
| 8 | \| | \| | \| | mⱼ ← mⱼ + 1 |
| 9 | \| | \| | \| | lⱼ ← (lⱼ, k} |
| 10 | \| | \| | end | |
| 11 | \| | end | | |
| 12 | end | | | |

| | |
|---|---|
| 13 | return {D, M, L} |

chose via probabilistic draw. Then, the experiences which had the removed experience as their neighbor remove it from their neighbor lists, and decrement their neighbor count. In processes 400 and 402, a distance from an experience to another experience is computed. One distance metric that can be used is Euclidean distance, e.g., on one of the experience elements only, such as state, or on any weighted combination of state, next state, action, and reward. Any other reasonable distance metric can be used. In process 400, there is a one-time quadratic all-pairs distance computation (lines 5-11, 406 in FIG. 4).

If the distance for an experience to another is less than a user-set parameter β, the experiences are considered neighbors. Each experience is coupled with a counter m that contains its number of neighbors to experiences currently in the memory, initially set in line 8 of process 400. Each experience stores a set of the identities of its neighboring experiences, initially set in line 9 of process 400. Note an experience will always be its own neighbor (e.g., line 3 in process 400). Lines 8 and 9 constitute box 408 in FIG. 4.

In process 402, a new experience is added to the memory. If the distance for the experience to any other experience currently in the memory (box 410) is less than the user-set parameter β, the counters for each are incremented (lines 8 and 9), and the neighbor sets updated to contain each other (lines 10 and 11). This is shown in boxes 412 and 414.

Process 404 shows how an experience is to be removed. The probability of removal is the number of neighbors divided by the total number of neighbors for all experiences (line 4 and box 416). SelectExperienceToRemove is a probabilistic draw to determine the experience o to remove. The actual removal involves deletion from memory (line 7, box 418), and removal of that experience o from all neighbor lists and decrementing neighbor counts accordingly (lines 8-13, box 418). Depending on implementation, a final bookkeeping step (line 14) might be necessary to adjust

{D, M, L} ← AddExperience(D, e_{new}, M, L): Process 402

| | // e_{new} : experience to add to the memory. | | |
|---|---|---|---|
| 1 | D ← StoreExperience(D, e_{new}) | | |
| 2 | r ← NumberOfExperiences(D) | | |
| 3 | eᵣ ← e_{new} | | |
| 4 | mᵣ ← 0 | | |
| 5 | lᵣ ← {r} | | |
| 6 | for j ← 1 to r do | | |
| 7 | \| | if d(eⱼ, eᵣ) < β then | |
| 8 | \| | \| | mⱼ ← mⱼ + 1 |
| 9 | \| | \| | mᵣ ← mᵣ + 1 |
| 10 | \| | \| | lⱼ ← {lⱼ, r} |
| 11 | \| | \| | lᵣ ← {lᵣ, j} |
| 12 | \| | end | |

| | |
|---|---|
| 13 | end |
| 14 | return {D, M, L} |

indices (i.e., all indices>o are decreased by one).

```
{D ,M, L} ← PruneExperience(D, M, L) : Process 404
  / /pⱼ: the probability experience j will be removed
  / /P: container for all probabilities
1 r ← NumberOfExperiences(D)
2 Mₛᵤₘ ← Σᵢ^{r} mᵢ
3 for j ← 1 to r do
4  ${p}_{j} = \frac{{m}_{j}}{{M}_{sum}}$
5 end
6 o ← SelectExperienceToRemove(P)
7 D ← DiscardExperience(D, o)
8 for j ← 1 to r do
9 if Contains(lⱼ, o) then
10 RemoveAsNeighbor(lⱼ, o)
11 mⱼ ← mⱼ − 1
12 end
13 end
14 D, M, L ← AdjustIndices(D, M, L)
15 return {D, M, L}
```

Processes 402 and 404 may happen iteratively and perhaps intermittently (depending on implementation) as the agent gathers new experiences. A requirement is that, for all newly gathered experiences, process 402 must occur before process 404 can occur.

Match-Based Pruning

An additional method for prioritizing (or pruning) experiences is based on the concept of match-based learning. The general idea is to assign each experience to one of a set of clusters, and compute distances for the purpose of pruning based on only the cluster centers.

In such online learning systems, an input vector (e.g., a one-dimensional array of input values) is multiplied by a set of synaptic weights and results in a best match, which can be represented as the single neuron (or node) whose set of synaptic weights most closely matches the current input vector. The single neuron also codes for clusters, that is, it can encode not only single patterns, but average, or cluster, sets of inputs. The degree of similarity between the input pattern and the synaptic weights, which controls whether the new input is to be assigned to the same cluster, can be set by a user-defined parameter.

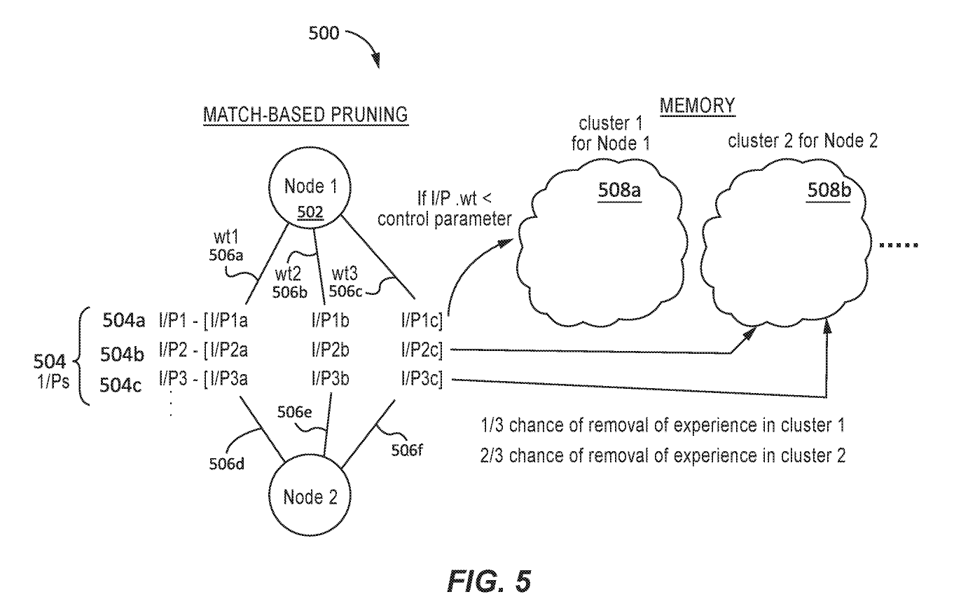

FIG. 5 illustrates an example match-based pruning process 500. In an online learning system, an input vector 504a is multiplied by a set of synaptic weights, for example, 506a, 506b, 506c, 506d, 506e, and 506f (collectively, synaptic weights 506). This results in a best match, which is then represented as a single neuron (e.g., node 502), whose set of synaptic weights 506 closely matches the current input vector 504a. The node 502 represents cluster 508a. That is, node 502 can encode not only single patterns, but represent, or cluster, sets of inputs. For other input vectors, for example, 504b and 504c (collectively, input vectors 504), the input vectors are multiplied by the synaptic weights 506 to determine a degree of similarity. In this case, the best match of 504b and 504c is node 2, representing cluster 508b. In this simple case, there are two experiences in cluster 2 and one in cluster 1, and the probability of removal is weighted accordingly. E.g., there is a ⅔ chance cluster 2 will be selected, at which point one of the two experiences is selected at random for pruning.

Further, whether an incoming input pattern is encoded within an existing cluster (namely, the match satisfies the user-defined gain control parameter) can be used to automatically select (or discard) the experience to be stored in the memory. Inputs that fits existing clusters can be discarded, as they do not necessarily add additional discriminative information to the sample memories, whereas inputs that do not fit with existing clusters are selected because they represent information not previously encoded by the system. An advantage of such a method is that the distance calculation is an efficient operation since only distances to the cluster centers need to be computed.

```
D ← MatchBasedPruning(D, Γ, d, β, Z) : Process 500
  / /D = {e₁, e₂, . . . , e_{N}}: experience memory
  / /Γ: encoder that converts an experience into a vector for clustering
  / /K: number of clusters, starts at one, grows
  / /W = [w₁, w₂, . . . , w_{K}]: matrix of cluster centers (column vectors)
  / /h = {h₁, h₂, . . . , h_{K}}: number of members per cluster
  / /r = {r₁, r₂, . . . , r_{K}}: distances of each cluster center to an experience
  / /Z: number of experiences to remove
  / /B = {B₁, B₂, . . . , B_{K}}: sets of experience indices that belong to each
    cluster
  / /Initialize first cluster
1 w₁ ← Γ(e₁), K ← 1, h₁ ←1, B₁ ←BelongsTo(1)
  / /Assign experiences to clusters
2 for j ← 2 to N do
3  for k ← 1 to K do
4  rⱼ ← d(Γ(eⱼ), wₖ)
5  end
6  if min(r) > β then
      / /Create new cluster
7  K ← K + 1
8  w_{K} ← Γ(eⱼ)
9  hₖ ← 1
10 B_{K} ← BelongsTo(j)
11 end
12 else
      / /Experience j belongs to cluster c
13 c ← argmin_{c} r_{c}
14 h_{c} ← h_{c} + 1
15 B_{c} ← BelongsTo(j)
16 end
17 end
  / /Probabilistic weighting
18 H ← Σₖ hₖ
19 for j ← 1 to K do
20  ${p}_{k} ← \frac{{h}_{j}}{H}$
21 end
  / /Remove
22 for i ← 1 to Z do
23 {D, o} ← RemoveExperience(p, D)
24 hₒ ← hₒ − 1
25 p ← ReweightClusters (h)
26 end
27 return D
```

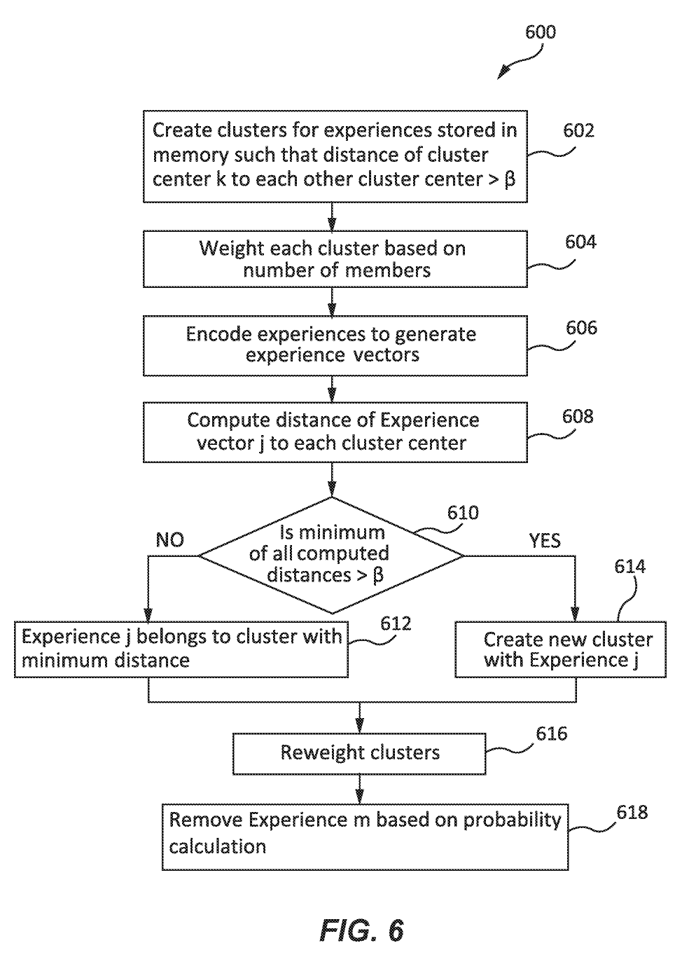

FIG. 6 is a flow diagram depicting an alternative representation 600 of the cluster-based pruning process 500 of FIG. 5. Clustering eliminates the need to compute either distances or store elements. In process 600, at 602, clusters are created such that the distance of the cluster center for every cluster k to each other cluster center is no more than β. Each experience in experience memory D is assigned to a growing set of K<<N cluster. After the experiences have been assigned to clusters, at 604, each cluster is weighted according to the number of members (lines 17-21 in pseudocode Process 600). Clusters with more members have a higher weight, and a greater chance of having experiences removed from them.

Process 600 introduces an “encoding” function Γ, which converts an experience {xⱼ, aⱼ, rⱼ, xⱼ₊₁} into a vector. The basic encoding function simply concatenates and properly weights the values. Another encoding function is discussed in the section below. At 606, each experience in the experience memory D, is encoded. At 608, the distance of an encoded experience to each existing cluster center is computed. At 610, the computed distances are compared with all existing cluster centers. If the most similar cluster center is not within β then at 614, a new cluster center is created with experience. However, if the most similar cluster center is within β, at 612, experience is assigned to the cluster that is most similar. That is, experience is assigned to a cluster with a cluster center that is at a minimum distance from experience compared to other cluster centers. At 616, the clusters are reweighted according to the number of members and at 618, one or more experience is removed based on a probabilistic determination. Once an experience is removed (line 23 in pseudocode Process 600), the clusters are reweighted accordingly (line 25 in pseudocode Process 600). In this manner, process 600 preferentially removes a set of Z experiences from the clusters with most members.

Process 600 does not let the cluster centers adapt over time. Nevertheless, it can be modified so that the cluster centers do adapt over time, e.g., by adding the following updating function in between line 15 and line 16.

$${w}_{c} ← \frac{1}{{h}_{c}} Γ ( {e}_{j} ) + ( 1 - \frac{1}{{h}_{c}} ) {w}_{c}$$

Encoder-Based Pruning

When the input dimension is high (as in the case of raw pixels), Euclidean distance tends to be a poor metric. It may not be easy or even possible to find a suitable β. Fortunately, there are an abundance of methods to reduce the dimensionality and potentially find an appropriate low-dimensional manifold, upon which Euclidean distance will make more sense. Examples include Principal Component Analysis, Isomap, Autoencoders, etc. A particularly appealing encoder is Slow Feature Analysis (SFA), which is well-suited for reinforcement learning. This is (broadly) because SFA takes into account how the samples change over time, making it well-suited to sequential decision problems. Further, there is a recently developed incremental method for updating a set of slow features (IncSFA), having linear computational and space complexities.

Using IncSFA as an encoder involves updating a set of slow features with each sample as the agent observes it, and, when the time comes to prune the memory, use the slow features as the encoding function Γ. The details to IncSFA are found in Kompella et al., “Incremental slow feature analysis: Adaptive low-complexity slow feature updating from high-dimensional input streams,” Neural Computation, 24(11):2994-3024, 2012, which is incorporated herein by reference.

An example process, for double DQN, using an online encoder is shown in Process 4 (below). Although this process was conceived with IncSFA in mind, it applies to many different encoders.

D ← DoubleDQNEncodingPruning
(Γ, d, β, η, ξ, τ, Dₘₐₓ, Z, R): Process 4

| | //Γ: incrementally updated encoder (e.g., IncSFA) | | | |
|---|---|---|---|---|
| | //d = (eⱼ, eₖ): distance metric to compare two experiences | | | |
| | //β: distance threshold | | | |
| | //η: replay period | | | |
| | //ε: minibatch size | | | |
| | //τ: network weight copy period | | | |
| | //Dₘₐₓ: maximum size of D | | | |
| | //Z: number of experiences to prune at each pruning stage | | | |
| | //T: end of time | | | |
| 1 | Initialize experience memort D = { } | | | |
| 2 | Initialize network weights θ₀, θ₀⁻ | | | |
| 3 | Observe s₀, choose a₀~π₀ (s₀) | | | |
| 4 | for t ← 1 to T do | | | |
| 5 | \| | Observe sₜ, rₜ | | |
| 6 | \| | Store experience eₜ = {sₜ₋₁, aₜ₋₁, rₜ₋₁, sₜ} in D | | |
| 7 | \| | Γ ← UpdateEncoder (Γ, eₜ) | | |
| 8 | \| | if t = 0 mod η then | | |
| 9 | \| | \| | for j ← 1 to ξ do | |
| 10 | \| | \| | \| | eⱼ ← SampleTransition(D) |
| 11 | \| | \| | \| | xⱼ = ϕ(sⱼ₋₁) yⱼ = rⱼ₋₁ + γQ(x_{j,} arg max_{a′}, Q(xⱼ, a′; θₜ);θₜ⁻) |
| 12 | \| | \| | \| | θ ← UpdateWeights(xⱼ, yⱼ, θ) |
| 13 | \| | \| | end | |

| 14 | \| | end | |
|---|---|---|---|
| 15 | \| | if t = 0 mod τ then | |
| 16 | \| | \| | Copy weights to target net θₜ⁻ ← θₜ |

| 17 | \| | end | |
|---|---|---|---|
| 18 | \| | if \|D\| > Dₘₐₓ then | |
| 19 | \| | \| | D ← RemoveExperiencesFromMemory(d, Γ, d, β, Z) |

| | | |
|---|---|---|
| 20 | \| | end |

| | | |
|---|---|---|
| 21 | \| | Choose action aₜ~π_{θ} (sₜ) |

| | |
|---|---|
| 22 | end |

A System that Uses Deep Reinforcement Learning and Experience Replay

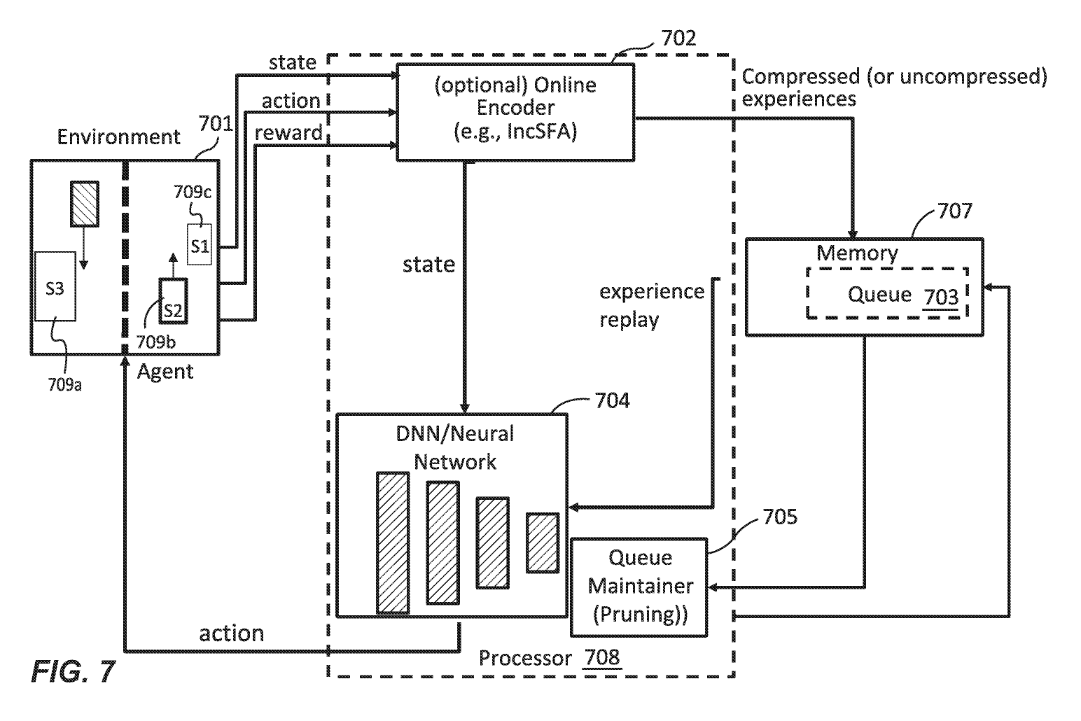

In FIG. 7, one or more agents, either in a virtual, or simulated environment, or physical agents (e.g., a robot, a drone, a self-driving car, or a toy) interact with their surroundings and other agents in a real environment 701. These agents and the modules (including those listed below) to which they are connected or include can be implemented by appropriate processors or processing systems, including, for example, graphics processing units (GPUs) operably coupled to memory, sensors, etc.

An interface (not shown) collects information about the environment 701 and the agents using sensors, for example, 709a, 709b, and 709c (collectively, sensors 709). Sensors 709 can be any type of sensor, such as image sensors, microphones, and other sensors. The states experienced by the sensors 709, actions, and rewards are fed into an online encoder module 702 included in a processor 708.

The processor 708 can be in digital communication with the interface. In some inventive aspects, the processor 708 can include the online encoder module 702, a DNN 704, and a queue maintainer 705. Information collected at the interface is transmitted to the optional online encoder module 702, where it is processed and compressed. In other words, the Online Encoder module 702 reduces the data dimensionality via Incremental Slow Feature Analysis, Principal Component Analysis, or another suitable technique. The compressed information from the Online Encoder module 702, or the non-encoded uncompressed input if an online encoder is not used, is fed to a Queue module 703 included in a memory 707.

The memory 707 is in digital communication with the processor 708. The queue module 703 in turn feeds experiences to be replayed to the DNN module 704.

The Queue Maintainer (Pruning) module 705 included in the processor 708 is bidirectionally connected to the Queue module 703. It acquires information about compressed experiences, and manages what experiences are kept and which one are discarded in the Queue module 703. In other words, the queue maintainer 705 prunes the memory 707 using on pruning methods such as process 300 in FIG. 3, process 400 and 402 in FIG. 4, process 500 in FIG. 5, and process 600 in FIG. 6. Memories from the Queue module 703 are then fed to the DNN/Neural Network module 704 during the training process. During the performance/behavior process, the state information from the environment is also provided from the agent(s) 701, and this DNN/Neural Network module 704 then generates actions and controls the agent in the environment 701, closing the perception/action loop.

Pruning, Deep Reinforcement Learning, and Experience Reply for Navigation

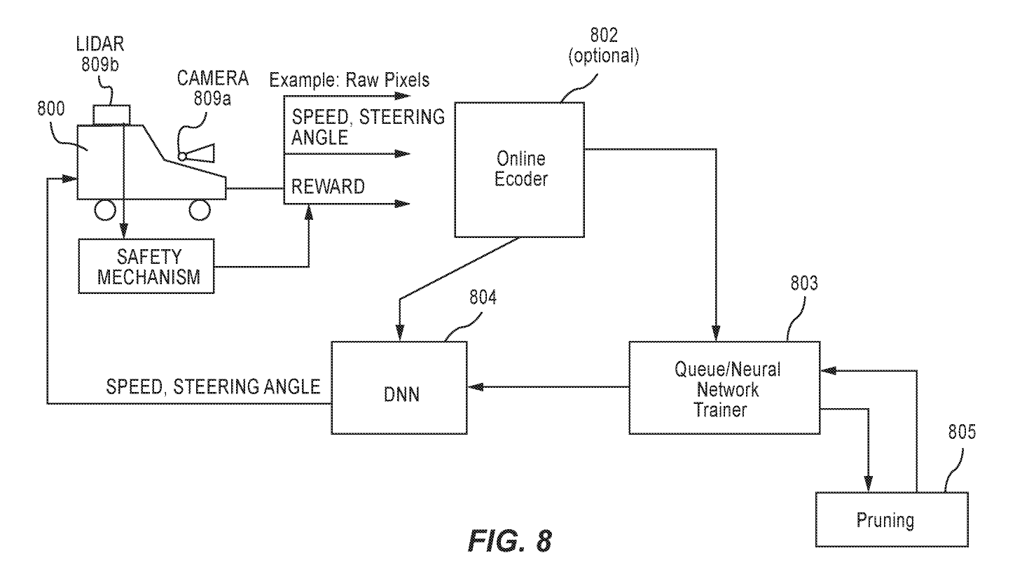

FIG. 8 illustrates a self-driving car 800 that that uses deep RL and Experience Replay for navigation and steering. Experiences for the self-driving car 800 are collected using sensors, such as camera 809a and LIDAR 809b coupled to the self-driving car 800. The self-driving car 800 may also collect data from the speedometer and sensors that monitor the engine, brakes, and steering wheel. The data collected by these sensors represents the car's state and action(s).

Collectively, the data for an experience for the self-driving car can include speed and/or steering angle (equivalent to action) for the self-driving car 800 as well as the distance of the car 800 to an obstacle (or some other equivalent to state). The reward for the speed and/or steering angle may be based on the car's safety mechanisms via Lidar. Said another way, the reward may be depend on the car's observed distance from an obstacle before and after an action. The car's steering angle and/or a speed after the action may also affect the reward, which higher distances and lower speeds earning higher rewards and collisions or collision courses earning lower rewards. The experience, including the initial state, action, reward, and final state are fed into an online encoder module 802 that processes and compresses the information and in turn feeds the experiences to the queue module 803.

The Queue Maintainer (Pruning) module 805 is bidirectionally connected to the Queue module 803. The queue maintainer 805 prunes the experiences stored in the queue module 803 using methods such as process 300 in FIG. 3, process 400 and 402 in FIG. 4, process 500 in FIG. 5, and process 600 in FIG. 6. Similar experiences are removed and non-similar experiences are stored in the queue module 803. For instance, the queue module 803 may include speeds and/or steering angles for the self-driving car 800 for different obstacles and distances from the obstacles, both before and after actions taken with respect to the obstacles. Experiences from the queue module 803 are then used to train to the DNN/Neural Network module 804. When the self-driving car 800 provides a distance of the car 800 from a particular obstacle (i.e., state) to the DNN module 804, the DNN module 804 generates a speed and/or steering angle for that state based on the experiences from the queue module 803.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of designing and making the technology disclosed herein may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes (e.g., of designing and making the technology disclosed above) outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A computer-implemented method for generating an action for a robot, the method comprising:
collecting a first experience for the robot, the first experience representing:
a first state of the robot at a first time,
a first action taken by the robot at the first time,
a first reward received by the robot in response to the first action, and
a second state of the robot in response to the first action at a second time after the first time;
determining a degree of similarity between the first experience and a plurality of experiences stored in a memory for the robot;
pruning the plurality of experiences in the memory based on the degree of similarity between the first experience and the plurality of experiences to form a pruned plurality of experiences stored in the memory;
training a neural network associated with the robot with the pruned plurality of experiences; and
generating a second action for the robot using the neural network.

2. The computer-implemented method of claim 1, wherein the pruning further comprises:
for each experience in the plurality of experiences:
computing a distance from the first experience; and
comparing the distance to another distance of that experience from each other experience in the plurality of experiences; and
removing a second experience from the memory based on the comparison, the second experience being at least one of the first experience and an experience from the plurality of experiences.

3. The computer-implemented method of claim 2, further comprising removing the second experience from the memory based on a probability that the distance of the second experience from the first experience and each experience in the plurality of experiences is less than a user-defined threshold.

4. The computer-implemented method of claim 1, where the pruning further includes ranking the first experience and each experience in the plurality of experiences.

5. The computer-implemented method of claim 4, wherein the ranking includes creating a plurality of clusters based at least in part on synaptic weights and automatically discarding the first experience upon determining that the first experience fits one of the plurality of clusters.

6. The computer-implemented method of claim 5, wherein the ranking includes encoding each experience in the plurality of experiences, encoding the first experience, and comparing the encoded experiences to the plurality of clusters.

7. The computer-implemented method of claim 1, wherein at a first input state the neural network generates an output based at least in part on the pruned plurality of experiences.

8. The computer-implemented method of claim 1, wherein the pruned plurality of experiences includes a diverse set of states of the robot.

9. The computer-implemented method of claim 1, wherein the generating the second action for the robot includes determining that the robot is in the first state and selecting the second action to be different than the first action.

10. The computer-implemented method of claim 9, further comprising:
receiving a second reward by the robot in response to the second action.

11. The computer-implemented method of claim 1, further comprising:
collecting a second experience for the robot, the second experience representing:
a second state of the robot,
the second action taken by the robot in response to the second state,
a second reward received by the robot in response to the second action, and
a third state of the robot in response to the second action;
determining a degree of similarity between the second experience and the pruned plurality of experiences; and
pruning the pruned plurality of experiences in the memory based on the degree of similarity between the second experience and the pruned plurality of experiences.

12. A system for generating a second action for a robot, the system comprising:
an interface to collect a first experience for the robot, the first experience representing:
a first state of the robot at a first time,
a first action taken by the robot at the first time,
a first reward received by the robot in response to the first action, and
a second state of the robot in response to the first action at a second time after the first time;
a memory to store at least one of a plurality of experiences and a pruned plurality of experiences for the robot;
a processor, in digital communication with the interface and the memory, to:
determine a degree of similarity between the first experience and the plurality of experiences stored in the memory;
prune the plurality of experiences in the memory based on the degree of similarity between the first experience and the plurality of experiences to form the pruned plurality of experiences;
update the memory to store the pruned plurality of experiences;
train a neural network associated with the robot with the pruned plurality of experiences; and
generate the second action for the robot using the neural network.

13. The system of claim 12, further comprising:
a cloud brain, in digital communication with the processor and the robot, to transmit the second action to the robot.

14. The system of claim 12, wherein the processor is further configured to:
for each experience in the plurality of experiences:
compute a distance from the first experience; and
compare the distance to another distance of that experience from each other experience in the plurality of experiences; and
remove a second experience from the memory based on the comparison, the second experience being at least one of the first experience and an experience from the plurality of experiences.

15. The system of claim 14, wherein the processor is configured to remove the second experience from the memory based on a probability determination of the distance of the second experience from the first experience and each experience in the plurality of experiences being less than a user-defined threshold.

16. The system of claim 12, wherein the processor is configured to prune the memory based on ranking the first experience and each experience in the plurality of experiences.

17. The system of claim 16, wherein the processor is further configured to:
create a plurality of clusters based at least in part on synaptic weights;
rank the first experience and the plurality of experiences based on the plurality of clusters; and
automatically discard the first experience upon determination that the first experience fits one of the plurality of clusters.

18. The system of claim 17, wherein the processor is further configured to encode each experience in the plurality of experiences, encode the first experience, and compare the encoded experiences to the plurality of clusters.

19. The system of claim 12, wherein at a first input state the neural network generates an output based at least in part on the pruned plurality of experiences.

20. A computer-implemented method for updating a memory, the memory storing a plurality of experiences received from a computer-based application, the method comprising:
receiving a new experience from the computer-based application;
determining a degree of similarity between the new experience and the plurality of experiences;
adding the new experience based on the degree of similarity;
removing at least one of the new experience and an experience from the plurality of experiences based on the degree of similarity; and
sending an updated version of the plurality of experiences to the computer-based application.
